(19) United States
(12) Patent Application Publication
(10) Pub. No.: US 2003/0127046 A1
(43) Pub. Date: Jul. 10, 2003

(54) Paint spray gun cleaner

(75) Inventors: Jeffrey S. Zehner, Tomahawk, WI (US); Wayne C. Fawley, Tomahawk, WI (US); Donald E. Bushar, Tomahawk, WI (US)

Correspondence Address: Kevin P. Moran, Esq., Michael Best & Friedrich LLP, 100 East Wisconsin Avenue, Milwaukee, WI, 53202-4108, US

(73) Assignee: Harley-Davidson Motor Company Group, Inc., Milwaukee, WI (US)

(21) Appl. No.: 10/042,591

(22) Filed: Jan. 9, 2002

(51) Int. Cl. A46B 13/04; B08B 1/00; B08B 7/04

(52) U.S. Cl. 118/302; 15/21.1; 15/88.3; 134/6; 118/326

(57) ABSTRACT

An apparatus for cleaning a spraying end of a paint sprayer includes a solvent vessel having an opening and containing a solvent. The opening is configured to receive the spraying end of the paint sprayer. A rotatable brush is only partially submerged in the solvent such that the spraying end contacts the brush when inserted into the opening. A motor is interconnected with and provides rotation to the brush. A signal generator is operable to provide an actuation signal that activates the motor such that the brush rotates and cleans paint from the spraying end of the paint gun.

### BACKGROUND

The invention relates to cleaning devices and more particularly devices for cleaning paint spray guns.

### SUMMARY

The present invention provides an apparatus for cleaning a spraying end of a paint sprayer. The apparatus includes a solvent vessel having an opening and containing a solvent. The opening is configured to receive the spraying end of the paint sprayer. A rotatable brush is only partially submerged in the solvent such that the spraying end contacts the brush when the spraying end is inserted into the opening. A motor (e.g. a pneumatic motor)is interconnected with and provides rotation to the brush. A signal generator is operable to provide an actuation signal that activates the motor such that the brush rotates and cleans paint from the spraying end of the paint sprayer.

The brush preferably includes a plurality of flexible bristles and is mounted within the vessel such that a portion of the brush is below the solvent level and a portion of the brush is above the solvent level. Preferably, the motor is configured to rotate the brush in alternating directions each time the spraying end is inserted into the opening. The brush preferably rotates about a substantially horizontal brush axis that is below the solvent level and the spraying end may be inserted into the opening substantially perpendicularly to the brush axis. The spraying end preferably contacts an outer surface of the brush during cleaning.

The signal generator may include a limit switch that is positioned adjacent the opening. The limit switch may be configured to provide the actuation signal in response to insertion of the spraying end into the opening. The vessel may also include a top wall and the opening may be smaller than the top wall.

The present invention also provides a method for cleaning a spraying end of a paint spray gun. The method includes providing a solvent vessel defining a chamber that contains a solvent at a solvent level. A rotatable brush is partially submerged in the solvent within the vessel such that a portion of the brush is above the solvent level. The spraying end of the paint spray gun is inserted into the chamber through the opening and the brush is rotated. The spraying end engages the exposed portion of the brush and paint is removed from the spraying end.

A motor may be operably connected to the brush, and a limit switch may be provided that communicates with the motor. The limit switch preferably operates in response to the insertion of the spraying end into the chamber. In this regard, the limit switch signals the motor to rotate upon insertion of the spraying end into the chamber.

The present invention also provides a paint spraying system for electronically controlled painting of a product. The system includes an enclosure, a conveying apparatus for conveying the product through the enclosure, and an electronic controller. A manipulator is positioned within the enclosure and operates in response to signals received from the electronic controller. The manipulator is operable to provide movement in a plurality of directions to a paint spraying nozzle that is coupled to the manipulator for movement therewith. A cleaning box is positioned within the enclosure and contains a solvent. The cleaning box includes an opening and houses a rotatable brush. A signal generator communicates with the rotatable brush and the brush rotates in response to an actuation signal provided by the signal generator.

In response to receiving a cleaning signal from the controller, the manipulator inserts the paint spraying nozzle through the opening and into the cleaning box. The signal generator signals the brush to rotate, and the nozzle contacts the rotating brush such that paint is cleaned from the nozzle.

### BRIEF DESCRIPTION OF THE DRAWINGS

FIG. 1 is a rear left perspective view of a paint spray gun cleaner embodying the present invention.

FIG. 2 is a front right perspective view of the paint spray gun cleaner.

FIG. 3 is a top view of the paint spray gun cleaner with the lid in an open position.

FIG. 4 is a section view taken along line 4-4 of FIG. 1.

FIG. 5 is a perspective view, with a portion cut away, of an automated paint spraying booth including a paint spray gun cleaner of the present invention.

Before one embodiment of the invention is explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein is for the purpose of description and should not be regarded as limiting. The use of “including” and “comprising” and variations thereof herein is meant to encompass the items listed thereafter and equivalents thereof as well as additional items. The use of “consisting of” and variations thereof herein is meant to encompass only the items listed thereafter. The use of letters to identify elements of a method or process is simply for identification and is not meant to indicate that the elements should be performed in a particular order.

### DETAILED DESCRIPTION

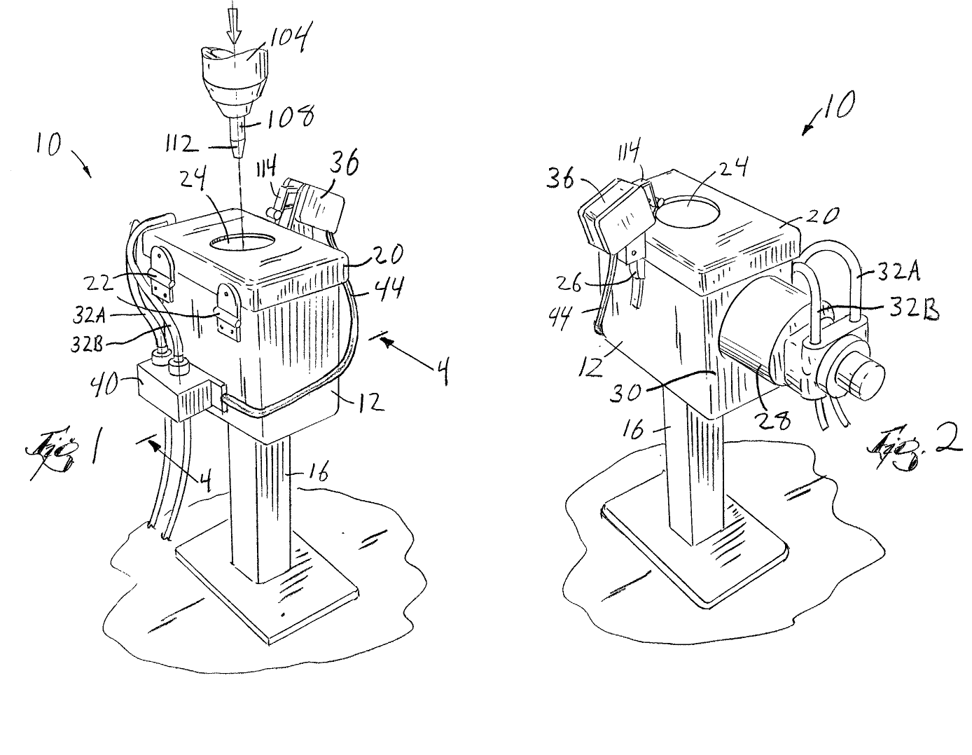

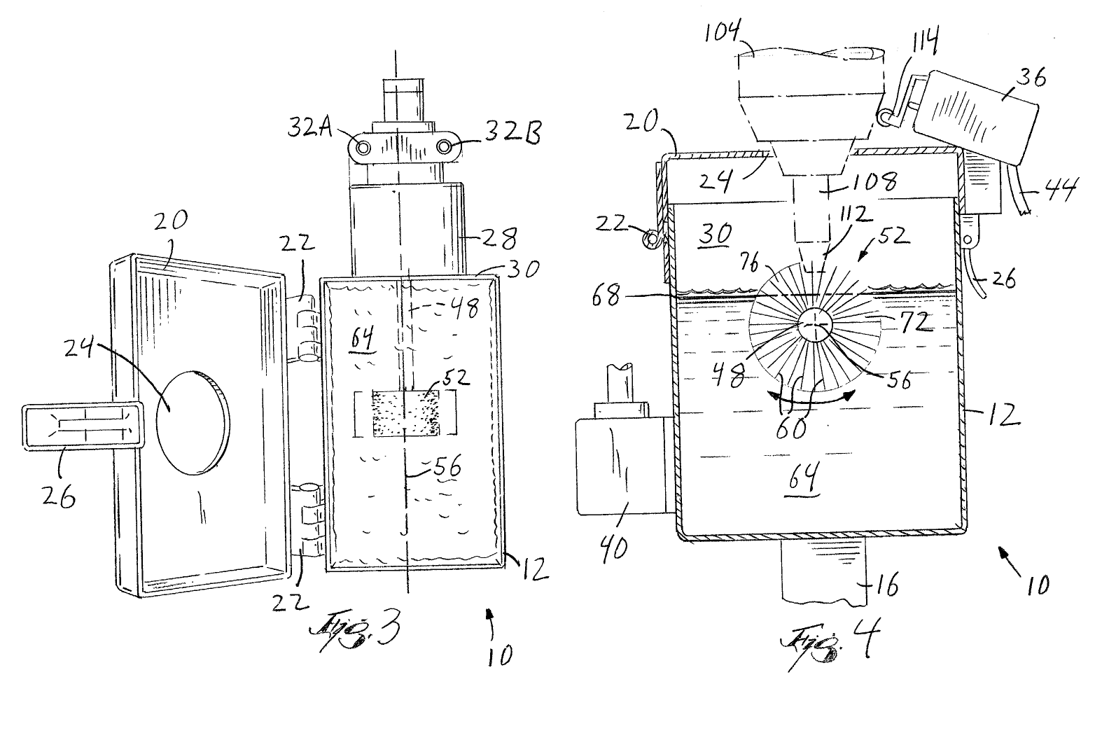

FIGS. 1 and 2 illustrate a paint spray gun cleaner 10 of the present invention. The cleaner includes a solvent container 12 supported by a leg 16 that is secured to or supported by the floor of a paint spraying area. A lid 20 is pivotally coupled to the container 12 by hinges 22 and is movable between an open position and a closed position. The lid 20 includes an aperture 24 that provides access to the container 12 when the lid 20 is in the closed position. A latch 26 is also provided to secure the lid 20 in the closed position. A pneumatic motor 28 is secured to an external side wall 30 of the container 12 and is coupled to air lines 32A, 32B. A signal generator in the form of a limit switch 36 is mounted to the lid 20 and electrically communicates with an air solenoid 40 through wires 44. The air solenoid 40 receives compressed air from an air compressor (not shown) and cooperates with the limit switch 36 to regulate the delivery of the compressed air to the pneumatic motor 28 as described further below.

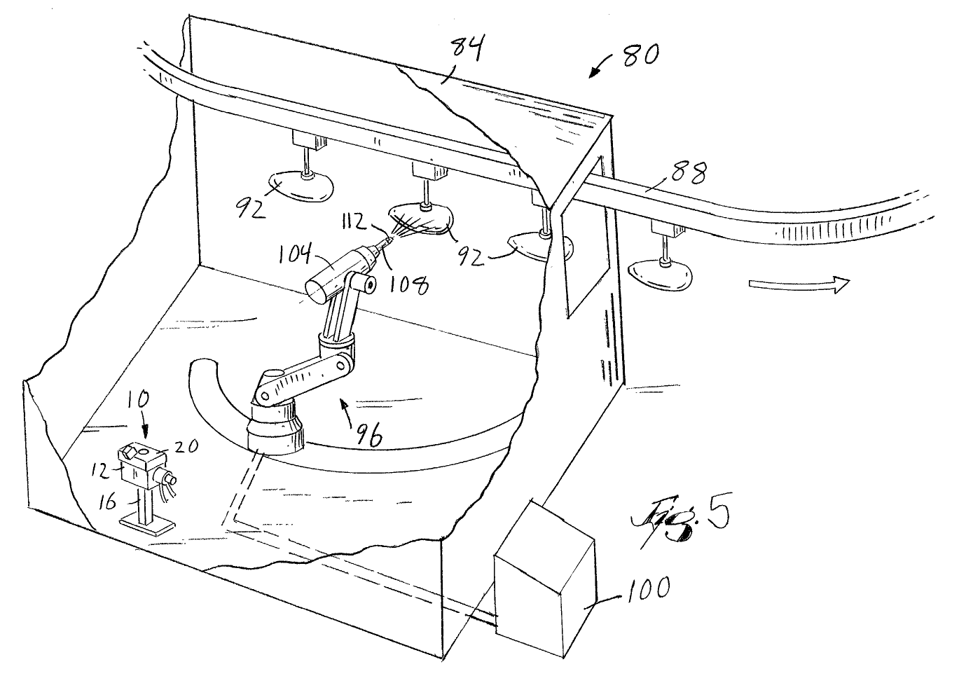

Referring now also to FIGS. 3 and 4, the pneumatic motor 28 includes a rotatable drive shaft 48 extending through the side wall 30 and into the container 12. A brush 52 is secured to the end of the drive shaft 48 for rotation therewith about a brush axis 56. The brush 52 includes a plurality of bristles 60 extending radially from the brush axis 56. In some embodiments, the bristles 60 are constructed of Nylon®. An appropriate brush 52 for use with the present invention is available from McMaster-Carr Supply Company of Elnhurst, Ill. as Item #4747A62.

The container 12 is partially filled with a liquid solvent solution 64 to a solvent level 68. The solvent level 68 is regulated such that a submerged portion 72 of the brush 52 is below the solvent level 68 and submerged in the solvent solution 64, and an exposed portion 76 of the brush 52 is above the solvent level 68 and not submerged in the solvent solution 64. The solvent level 68 is preferably maintained above the drive shaft 48 for optimal performance of the spray gun cleaner 10. A suitable solvent solution 64 for use with the present invention is Poly-Purge® brand solvent solution, which is available from PPG Industries, Inc. of Pittsburgh, Pa.

The spray gun cleaner 10 is particularly well suited for use in an automated paint spraying line 80 as illustrated in FIG. 5. The spraying line 80 includes an enclosure 84 having a product conveyor 88 passing therethrough. The conveyor 88 is of conventional design and conveys a product 92 from one end of the enclosure 84 to the other. The spraying line 80 also includes an electronically controlled manipulator 96 operating in response to signals received from a controller 100. The manipulator 96 includes an end effector 104 that has a paint spraying nozzle 108. The manipulator 96 guides the end effector 104 along a predetermined path to apply paint to the product 92 as the product 92 is conveyed through the enclosure 84.

As the paint spraying nozzle 108 sprays paint upon the individual products 92, paint begins to accumulate on a tip 112 of the nozzle 108. If an excessive amount of paint accumulates on the tip 112, the quality of the paint spraying operation will be adversely affected and the aesthetic appearance of the finished product 92 will degrade. To avoid this situation, the controller 100 is programmed to provide a cleaning signal to the manipulator 96 after a predetermined quantity of product 92 has been painted. Upon receiving the cleaning signal, the manipulator 96 guides the end effector 104 toward the spray gun cleaner 10.

As best illustrated in FIG. 4, the manipulator 96 inserts the nozzle 108 through the aperture 24 in the lid 20, and into the container 12. The nozzle 108 is inserted substantially vertically in the illustrated construction, but may be inserted at an angle in alternate constructions. In any event, it is preferred to insert the nozzle 108 substantially perpendicularly to the brush axis 56.

As the tip 112 engages the bristles 60 of the brush 52, a portion of the end effector 104 contacts a trigger 114 on the limit switch 36. As the end effector 104 engages the trigger 114, an actuation signal is provided to the air solenoid 40 via the wires 44. Upon receipt of the actuation signal, the solenoid 40 opens the first air line 32A (see FIGS. 2, 3) that communicates with an impeller (not shown) of the pneumatic motor 28 on a first side of the brush axis 56. Pressurized air flows from the solenoid 40 toward the pneumatic motor 28 and impinges upon and thereby rotates the impeller in a first direction. The impeller is coupled to the drive shaft 48 such that rotation of the impeller imparts rotation to the brush 52.

As the brush 52 rotates, solvent solution 64 is applied to the tip 112 of the nozzle 108 by the exposed bristles 60. The solvent solution 64 thins the paint on the tip 112, and the bristles 60 loosen and remove the thinned paint from the tip 112. The bristles 60 then rotate back into the solvent solution 64 where the paint is subsequently rinsed from the bristles 60. The bristles 60 then rotate out of the solvent solution 64 to once again apply solvent solution 64 to the tip 112 and further clean the nozzle 108.

The tip 112 is maintained in contact with the rotating brush 52 for a predetermined amount of time to clean at least a portion of the paint from the tip 112. After the tip 112 has been sufficiently cleaned, the controller 100 signals the manipulator 96 to remove the nozzle 108 from the container 12, thereby disengaging the end effector 104 from the trigger 114 of the limit switch 36. The solenoid 40 then stops the flow of air to the pneumatic motor 28, thereby halting rotation of the brush 52. The manipulator 96 then guides the nozzle 108 toward the product 92 to perform additional painting operations.

Each time the predetermined quantity of product 92 has been painted, the manipulator 96 returns the nozzle 108 to the spray gun cleaner 10. The solenoid 40 is configured such that each subsequent insertion of the nozzle 108 into the container 12 results in rotation of the brush 52 in alternating directions. Specifically, the solenoid 40 alternately provides compressed air to the pneumatic motor 28 via the first air line 32A as described above, and the second air line 32B. The second air line 32B delivers compressed air to the pneumatic motor 28 such that it impinges upon the impeller on a second, opposite side of the brush axis 56 as the air from the first air line 32A. As such, delivery of compressed air to the motor 28 through the first air line 32A rotates the brush 52 in one direction (e.g. counter-clockwise) and delivery of compressed air to the motor 28 through the second air line 32B rotates the brush 52 in an opposite direction (e.g. clockwise).

Alternating the direction of rotation of the brush 52 in this manner results in improved cleaning of the tip 112 and longer life of the brush 52. For example, a first insertion of the tip 112 into the container 12 will generally clean one side of the tip 112 more completely than the other side of the tip 112. Similarly, the bristles 60 are flexed or bent in one direction as they contact the tip 112. A second insertion of the tip 112 into the container 12 will generally clean the other side of the tip 112 that was less completely cleaned after the first insertion. Similarly, the bristles 60 will be flexed or bent in an opposite direction during the second insertion, thereby facilitating a more even wearing of the brush 52 and preventing the bristles 60 from becoming permanently bent in one direction.

Alternatively, an electrically powered motor may be provided in place of the pneumatic motor 28. The electric motor should be selected to have suitable size and power to impart the required rotation to the brush 60. Appropriate control circuitry may be provided such that the electrical motor is capable of rotating the brush 60 in alternating directions substantially as described above with respect to the pneumatic motor 28. Various other types of motors and control devices may be suitable as well, so long as they provide adequate alternating rotation of the brush 60, substantially as described above.

Furthermore, various other sensors, devices, and methods for controlling the activation of the motor may be utilized in accordance with the present invention. For example, non-contact type sensors including photocells, proximity sensors and the like may be adapted for use with the spray gun cleaner 10 to detect the insertion of the tip 112 into the container 12, and provide an appropriate actuation signal to the air solenoid 40. Alternatively, the controller 100 may be configured to provide an actuation signal to the solenoid 40 which corresponds to the sending of the cleaning signal to the manipulator 96. In this regard, the actuation signal may be provided simultaneously with the cleaning signal, or may be delayed with respect to the cleaning signal to allow the manipulator 96 to reach the spray gun cleaner 10. It should be appreciated that any actuation signal, whether provided by various types of limit switches or by the controller 100, may be used to activate the motor 28.

Various features of the invention are set forth in the following claims.

What is claimed is:

1. An apparatus for cleaning a spraying end of a paint sprayer, said apparatus comprising:
a solvent vessel having an opening and containing a solvent at a solvent level, said opening configured to receive the spraying end of the paint sprayer;
a rotatable brush only partially submerged in the solvent, the spraying end contacting said brush when the spraying end is inserted into said opening;
a motor operably interconnected with and operable to selectively rotate said brush; and
a signal generator operable to provide an actuation signal that activates said motor, thereby rotating said brush wherein upon contact of the spraying end with said rotating brush, said brush cleans paint from the spraying end by applying the solvent to the spraying end.

2. The apparatus of claim 1, wherein said brush includes a plurality of flexible bristles.

3. The apparatus of claim 1, wherein a portion of said brush is below the solvent level and a portion of said brush is above the solvent level, and wherein the spraying end contacts said portion of said brush that is above the solvent level.

4. The apparatus of claim 1, wherein said motor is configured to rotate said brush in alternating directions in response to sequential insertions of the spraying end through said opening.

5. The apparatus of claim 1, wherein said motor comprises a pneumatic motor.

6. The apparatus of claim 1, wherein said brush rotates about a substantially horizontal brush axis, and wherein the spraying end is insertable into said opening substantially perpendicularly to said brush axis.

7. The apparatus of claim 1, wherein said brush rotates about a substantially horizontal brush axis, and wherein said brush axis is below the solvent level.

8. The apparatus of claim 1, wherein the spraying end contacts an outer surface of said brush.

9. The apparatus of claim 1, wherein said solvent vessel includes a top wall and wherein said opening is in said top wall and is smaller than said top wall.

10. The apparatus of claim 1, wherein said signal generator comprises a limit switch actuable to provide the actuation signal in response to insertion of the spraying end into said opening.

11. A method for cleaning a spraying end of a paint spray gun, the method comprising:
providing a solvent vessel having an opening and defining a chamber, the chamber containing a solvent at a solvent level
Partially submerging a rotatable brush in the solvent within the vessel such that a portion of the brush is above the solvent level;
inserting the spraying end of the paint spray gun into the chamber through the opening;
rotating the brush;
engaging the spraying end with the exposed portion of the brush; and
removing paint from the spraying end in response to the application of the solvent to the spraying end by the brush.

12. The method of claim 11, further comprising sensing said insertion of the spraying end into the chamber, and wherein said act of rotating occurs in response to sensing said insertion.

13. The method of claim 11, wherein said act of rotating includes operably connecting a motor to the brush, said method further comprising:
providing a limit switch that operates in response to said insertion of the spraying end into the chamber;
sensing said insertion with the limit switch; and
activating the motor in response to said sensing of said insertion.

14. The method of claim 11, wherein said act of rotating includes rotating the brush in one direction upon said insertion of the spraying end, and rotating the brush in an opposite direction upon a subsequent insertion of the spraying end.

15. A paint spraying system for electronically controlled painting of a product, said system comprising:
an enclosure;
a conveying apparatus for conveying the product through said enclosure;
an electronic controller;
a manipulator within said enclosure and operating in response to signals received from said electronic controller;
a paint spraying nozzle coupled to said manipulator, said manipulator operable to provide movement in a plurality of directions to said paint spraying nozzle;
a cleaning box within said enclosure, said cleaning box defining a chamber that contains a solvent at a solvent level and houses a partially submerged rotatable brush having an exposed portion that is above the solvent level, said box also including an opening communicating with said chamber; and
a signal generator communicating with said rotatable brush, said rotatable brush rotating in response to an actuation signal provided by said signal generator;
wherein in response to receiving a cleaning signal from said controller, said manipulator inserts said paint spraying nozzle through said opening and into said chamber, wherein said signal generator selectively signals said brush to rotate, and wherein said nozzle contacts said exposed portion of said brush to clean paint from said nozzle.

16. The system of claim 15, further comprising a motor mechanically coupled to said rotatable brush and communicating with said signal generator, said motor operating in response to said actuation signal from said signal generator to rotate said brush.

17. The system of claim 15, wherein said motor comprises a pneumatic motor.

18. The system of claim 15, wherein said brush rotates about a substantially horizontal brush axis, and wherein said nozzle is insertable into said opening substantially perpendicularly to said brush axis.

19. The system of claim 15, wherein said brush is configured to rotate in alternating directions in response to sequential insertions of said nozzle into said opening.

20. The system of claim 15, wherein said signal generator comprises a limit switch actuable to provide said actuation signal in response to insertion of said nozzle into said opening.

21. An apparatus for cleaning a spraying end of a paint sprayer, said apparatus comprising:
a solvent vessel having an opening and containing a solvent at a solvent level, said opening configured to receive the spraying end of the paint sprayer;
a rotatable brush having an exposed portion that is above the solvent level and a submerged portion that is below the solvent level, the spraying end contacting said exposed portion when the spraying end is inserted into said opening;
a motor operably interconnected with and operable to selectively rotate said brush; and
a limit switch engaged by the paint sprayer when the spraying end is inserted into said opening to activate said motor wherein said brush cleans paint from the spraying end by applying the solvent to the spraying end.

22. The apparatus of claim 21, wherein said brush includes a plurality of flexible bristles.

23. The apparatus of claim 21, wherein said motor is configured to rotate said brush in alternating directions in response to sequential insertions of the spraying end through said opening.

24. The apparatus of claim 21, wherein said motor comprises a pneumatic motor.

25. The apparatus of claim 21, wherein said brush rotates about a substantially horizontal brush axis, and wherein the spraying end is insertable into said opening substantially perpendicularly to said brush axis.

26. The apparatus of claim 21, wherein the spraying end contacts an outer surface of said brush.

27. The apparatus of claim 21, wherein said solvent vessel includes a top wall and wherein said opening is in said top wall and is smaller than said top wall.
